(19) United States
(12) Patent Application Publication
(10) Pub. No.: US 2003/0187933 A1
(43) Pub. Date: Oct. 2, 2003

(54) Data distribution infrastructure

(76) Inventor: William Beavin, St. Louis, MO (US)

Correspondence Address: JOHN R. RAFTER, BOEING MANAGEMENT COMPANY, 15460 LAGUNA CANYON ROAD, IRVINE, CA, 92618, US

(21) Appl. No.: 10/113,305

(22) Filed: Mar. 29, 2002

(51) Int. Cl. G06F 15/16

(52) U.S. Cl. 709/205

(57) ABSTRACT

The data distribution infrastructure includes user application systems; infrastructure subsystems; a run-time infrastructure (RTI); a communications subsystem; and, a connection subsystem. A first user application system is operable by a first user for communicating data with a second user. The first user application system is non-simulated, and includes a first infrastructure interface element. A second user application system is operable by the second user for communicating data with the first user application system. The second user application system is also non-simulated and includes a second infrastructure interface element. A first infrastructure subsystem provides interoperability between the first user application system and the second user application system. The first infrastructure subsystem includes: i) a first application interface subsystem in data communication with the first infrastructure interface element; ii) a first facility subsystem in data communication with the first application interface subsystem; and, iii) a first network subsystem in data communication with the first facility subsystem. A second infrastructure subsystem includes like components and provides interoperability between the first user application system and the second user application system. The run-time infrastructure (RTI) provides interoperability between the first and second application interface subsystems. A communications subsystem provides data communication between the first facility subsystem and the second facility subsystem. The connection subsystem provides connectivity between the first network subsystem and the second network subsystem.

### BACKGROUND OF THE INVENTION

1. Field of the Invention

This invention relates to data distribution infrastructures and, more particularly, to infrastructures that provide plug-and-play interoperability of user application systems as well as management of the distribution of data.

2. Description of the Related Art

Previous telemedicine infrastructures managed only the point to point connectivity of users exchanging data, but have not effectively managed the distribution of data itself. This shortcoming is especially evident in the creation of add hoc collaborations, where devices need to be connected to a network, and the user applications running on them need to immediately begin to interoperate. This would be the case in situations such as a natural or terrorist related disaster, a humanitarian relief effort, home healthcare situation, or configuration of an intensive care unit in a hospital setting.

Currently, such devices are linked primarily by two methods. Commonly, a point-to-point connection is established by entering the location of the remote device, usually a telephone number, web site, or internet address. This location, however, may not be available to the user, it may be inconvenient or impossible to enter, or require more technical background than available to the average user. It also relies on vendor specific interfaces which limits the devices supported to include only those with the same vendor specific interface.

Another method currently in use is to similarly utilize a proprietary interface, but also utilize a proprietary location database. For example, a patient device may automatically connect with a central server and from that central location is linked via the proprietary database with a particular provider device. Again, only devices supporting the vendor specific interface are supported.

Neither of these methods allows for an open system design, where any device using a standard interface can connect with a distributed run-time-infrastructure, and immediately begin to interoperate with appropriate other potentially multiple devices.

U.S. Pat. No. 6,283,923, issued to J. Finkelstein, discloses a system for remotely monitoring asthma severity including a remotely located asthma monitoring station for administering a patient self-test and for gathering test data and relevant patient information indicative of asthmatic symptoms. A central processing facility receives the test data and patient information from the remote monitoring station, determines whether the test data is valid, and analyzes valid test data to generate test results and an appropriate response message to the monitoring system. The test results are stored in a central data repository. The test results response messages are decimated as required. The monitoring system also includes a remotely located diagnosis/evaluation station for displaying the test results, response messages and other patient information. Selectable data links are provided for real-time reciprocal exchange of the test data, test results, response message and patient information between the monitoring station, and the central processing facility and the diagnosis/evaluation station.

U.S. Pat. No. 5,781,442 issued to J. J. Engleson, et al., discloses a system and method for collecting data and managing patient care. The system uses a gateway to connect an existing facility to another facility but does not provide for devices themselves to simply connect directly to a local or distributed infrastructure and interoperate with other local or remote devices.

### SUMMARY

The data distribution infrastructure of the present invention includes user application systems; infrastructure subsystems; a run-time infrastructure (RTI); a communications subsystem; and, a connection subsystem. A first user application system is operable by a first user for communicating data with a second user. The first user application system is non-simulated, and includes a first infrastructure interface element. A second user application system is operable by the second user for communicating data with the first user application system. The second user application system is also non-simulated and includes a second infrastructure interface element. A first infrastructure subsystem provides interoperability between the first user application system and the second user application system. The first infrastructure subsystem includes: i) a first application interface subsystem in data communication with the first infrastructure interface element; ii) a first facility subsystem in data communication with the first application interface subsystem; and, iii) a first network subsystem in data communication with the first facility subsystem. A second infrastructure subsystem provides interoperability between the first user application system and the second user application system. It includes: i) a second application interface subsystem in data communication with the second infrastructure interface element; ii) a second facility subsystem in data communication with the second application interface subsystem; and, iii) a second network subsystem in data communication with the second facility subsystem. The run-time infrastructure (RTI) provides interoperability between the first and second application interface subsystems. A communications subsystem provides data communication between the first facility subsystem and the second facility subsystem. The connection subsystem provides connectivity between the first network subsystem and the second network subsystem. Both plug and play interoperability of the first and second user application systems and management of the data communication between the user application systems are accomplished.

Previously, use of Run Time Infrastructures such as IEEE 1516 “High Level Architecture” have been limited to simulations developed by or used for the United States military, or militaries of other countries. However, the interoperability-enabling features of such an RTI are utilized in the present invention for applications other than simulations intended for military use, such as network enabled Electrocardiogram (EKG) telemedicine devices, airport security systems, or entertainment game consoles.

### BRIEF DESCRIPTION OF THE DRAWING

FIG. 1 is a schematic representation of the data distribution infrastructure of the present invention.

### DETAILED DESCRIPTION OF THE INVENTION

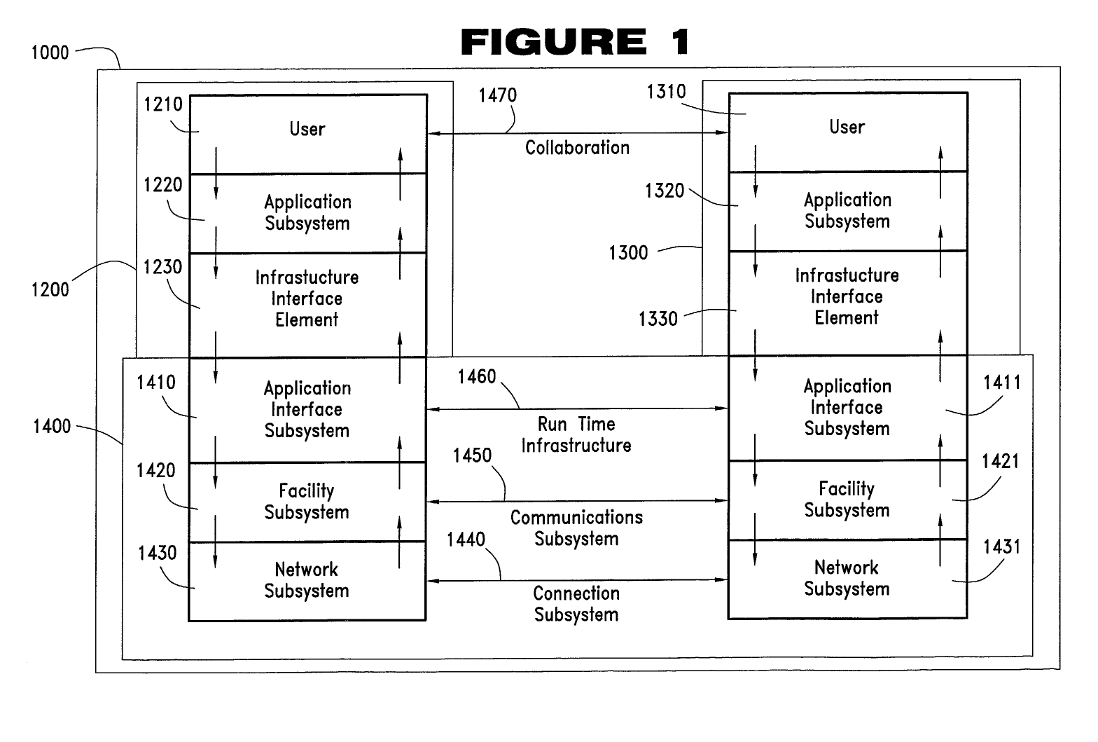

Referring to the drawings and the characters of reference marked thereon, FIG. 1 illustrates a preferred embodiment of the data distribution infrastructure of the present invention, designated generally as 1000. Although, particularly adapted for use with telemedicine applications, infrastructure 1000 may be used for a variety of applications such as for training, analyses, collaboration, entertainment, and homeland security. Although FIG. 1 shows implementation of the present system between two user application systems, 1200, 1300, the data distribution infrastructure 1000 may be composed of a potentially very large number of user application systems, such as for visual display, data analyses, medical diagnosis or military training. For simplicity, these potentially numerous systems are indicated by 1200 and 1300. An overall communications infrastructure system that allows the systems 1200 and 1300 to interoperate is indicated by infrastructure system 1400.

Application systems such as those generally indicated by numeral designations 1200 and 1300, include user application subsystems 1220 and 1320 operable by associated users 1210 and 1310. These user application subsystems may comprise numerous software programs, such as for media display and interaction, data visualization and mining, medical record access and display, and patient diagnostic data. These software programs could be running on a wide variety of devices, such as personal computers, video game stations, embedded systems, or medical devices, that provide desired functionality to the user. Each user application system 1200,1300 includes a respective infrastructure interface element 1230, 1330. The interface elements may be, for example, specified by ANSI medical interface standard HL7 or the medical diagnostic digital image communication (DICOM) standard. The application subsystems 1220, 1320 are non-simulated. As used herein the term “non-simulated” means that the actual device and the apparent device are, in fact, the same device. For instance, an actual aircraft flies in the sky, while a simulated one does not, even though it appears to do so. Therefore, the actual aircraft is considered non-simulated. However, even with simulated applications, such as a simulated aircraft, a Run Time Infrastructure, such as HLA, has only been used for military exercises. A Run Time Infrastructure that allows plug-and-play interoperability of entertainment-oriented applications, such as a simulated aircraft in a game device, is a significant improvement in the state of the art for entertainment oriented applications.

User application systems 1200 and 1300 can interoperate over an infrastructure system, indicated by 1400. The infrastructure system 1400 includes infrastructure subsystems, a run-time infrastructure (RTI) 1460, a communications subsystem 1450 and a connection subsystem 1440. Each infrastructure subsystem includes a respective application interface subsystem, e.g. 1410 or 141 1; a facility subsystem, e.g. 1420 or 1421; and, a network subsystem, e.g. 1430 or 1431. Application interface subsystem 1410 is in data communication with the infrastructure interface element 1230. The subsystem 1410 accesses data residing in the infrastructure element 1230. The devices and equipment necessary to connect them reside in their respective facility subsystem 1420 and 1421, and use internal memory, distributed shared memory, or other network connection devices and equipment, defining network subsystems, i.e. 1430 and 1431.

The connection subsystem 1440 physically links the distributed systems using network connectivity equipment of the network subsystems 1430 and 1431. Connection subsystem 1440 may be as simple as a local area network consisting of routers and network cables, or a complex wide area network with technologies such as satellite links, fiber optics, telephone lines, or wireless links.

The communications capability of communications subsystem 1450 is enabled by connection 1440 allowing computers and devices at each facility subsystem 1420 and 1421 to use standard communications protocols such as TCP/IP, UDP/IP, or ATM to exchange data.

The run-time infrastructure (RTI) 1460 relies on system 1440 connectivity and subsystem 1450 communications capability to allow interoperability to occur between application systems 1200 and 1300, through application interfaces 1410 and 1411. Through use of available interoperability standards for RTI 1460, such as the High Level Architecture (HLA) IEEE 1516 standard, applications may use the infrastructure system 1400 to interoperate without needing to be aware of most of the details of the 1400 infrastructure itself.

Application systems 1200 and 1300, which have some level of communication ability, often must use the same interface specification with all application systems needing to interoperate. Various industry standards have been adopted in order to accomplish this, such as HL7 and DICOM, which are in use by the healthcare industry. By having infrastructure 1400 in place, it is not necessary that all application subsystems 1220 and 1320, utilize the same interface specifications, such as HL7 or DICOM. The interface subsystems, 1410 and 1411, internally utilize whatever data format and content is convenient for application subsystems 1220 and 1320, and transform the data into run-time infrastructure communications standards, such as High Level Architecture IEEE 1516.

As an example of a preferred embodiment of the invention, user 1210 is a medical doctor performing a remote consultation 1470 with patient 1310. Doctor 1210 utilizes interaction capability 1220, such as provided by the CyberCare Electronic HouseCall System™ Provider Station EHC 600, or American Telecare AVIVA Central Station. Patient 1310 utilizes interaction capability 1320 such as provided by the TeleMedic VitalLink®1200, CyberCare Electronic HouseCall System™ Patient Station 500, or American Telecare AVIVA XR 1010 Patient Station.

Application subsystems 1220 and 1320 utilize internal data structures to input, store, present, and output data, such as voice or stethoscope audio, videoconference video, and patient diagnostic data. Standard formats such as the ANSI Standard HL7 specification for clinical and administrative data may be used. Proprietary implementations are alternately possible. In either case, these data formats can be interfaced through interfaces 1230, 1410 and 1330, 1411, to a standardized interoperability interface format, such as is specified by the High Level Architecture IEEE 1516 specification, and enable application interoperability.

In this example of the preferred embodiment of the invention, the application subsystems 1220, 1320 reside in the office, i.e. facility subsystem 1420, of doctor 1210 and the home, i.e. facility subsystem 1421, of patient 1310. Communications capability 1450 can be established utilizing standard means such as provided by dial-up Internet service providers, cable modem Internet service providers, or DSL Internet service providers.

Communications 1450 between these locations can be accomplished by numerous commonly known communications means, such as a Virtual Connection or Virtual Private Network. One means to establish the connection 1440 to enable communications 1450 is for both application subsystems or stations 1220 and 1320 to utilize a protocol such as Point-To-Point-Tunneling-Protocol (PPTP) into a common tunnel server, allowing secure communications between the stations.

RTIs have previously been exclusively designed and implemented for simulation purposes, and more specifically, for distributed military simulations. The most common RTI is the IEEE Standard 1516-2000 for Modeling and Simulation (M&S) High Level Architecture (HLA). It was developed as the mandated infrastructure for linking distributed military simulations. It was not intended, nor has it previously been used, as a means to link non-simulation applications, such as medical devices. The present invention applies this infrastructure in a broader sense than it has previously been envisioned. Rather than simply linking simulations, it can also be made to link real world systems, such as linking home health monitoring systems with care provider systems or numerous intensive care units in a hospital with a remote ICU monitoring system.

Obviously, many modifications and variations of the present invention are possible in light of the above teachings. It is, therefore, to be understood that within the scope of the appended claims, the invention may be practiced otherwise than as specifically described.

What is claimed and desired to be secured by Letters Patent of the United States is:

1. A data distribution infrastructure, comprising:
a) a first user application system operable by a first user for communicating data with a second user, said first user application system being non-simulated and comprising a first infrastructure interface element;
b) a second user application system operable by the second user for communicating data with said first user application system, said second user application system being non-simulated and comprising a second infrastructure interface element;
c) a first infrastructure subsystem for providing interoperability between said first user application system and said second user application system, comprising:
i) a first application interface subsystem in data communication with said first infrastructure interface element;
ii) a first facility subsystem in data communication with said first application interface subsystem; and,
iii) a first network subsystem in data communication with said first facility subsystem;
d) a second infrastructure subsystem for providing interoperability between said first user application system and said second user application system, comprising:
i) a second application interface subsystem in data communication with said second infrastructure interface element;
ii) a second facility subsystem in data communication with said second application interface subsystem; and,
iii) a second network subsystem in data communication with said second facility subsystem;
e) a run-time infrastructure (RTI) for providing interoperability between said first and second application interface subsystems;
f) a communications subsystem for providing data communication between said first facility subsystem and said second facility subsystem; and,
g) a connection subsystem for providing connectivity between said first network subsystem and said second network subsystem, wherein
both plug and play interoperability of said first and second user application systems and management of the data communication between said user application systems are accomplished.

2. The data distribution infrastructure of claim 1, wherein said application systems comprise telemedicine-related application systems.

3. The data distribution infrastructure of claim 1, wherein said RTI utilizes a high-level architecture (HLA) IEEE 1516 standard.

4. The data distribution infrastructure of claim 1, wherein said first user application system comprises a medical interface device.

5. The data distribution infrastructure of claim 1, wherein said communications subsystem comprises a virtual private connection system.

6. The data distribution infrastructure of claim 1, wherein said connection subsystem comprises a point to point tunneling protocol (PPTP).

7. The data distribution infrastructure of claim 1, wherein said user application systems use the ANSI standard HL7 specification.

8. The data distribution infrastructure of claim 1, wherein said user application systems use the DICOM specification.

9. A data distribution infrastructure for providing telemedicine, comprising:
a) a first user application system operable by a first user for communicating data with a second user, said first user application system comprising a first infrastructure interface element, said first user application being non-simulated and being telemedicine related;
b) a second user application system operable by the second user for communicating data with said first user application system, said second user application system comprising a second infrastructure interface element, second user application being non-simulated and being telemedicine related;
c) a first infrastructure subsystem for providing interoperability between said first user application system and said second user application system, comprising:
i) a first application interface subsystem in data communication with said first infrastructure interface element;
ii) a first facility subsystem in data communication with said first application interface subsystem; and,
iii) a first network subsystem in data communication with said first facility subsystem;
d) a second infrastructure subsystem for providing interoperability between said first user application system and said second user application system, comprising:
i) a second application interface subsystem in data communication with said second infrastructure interface element;
ii) a second facility subsystem in data communication with said second application interface subsystem; and,
iii) a second network subsystem in data communication with said second facility subsystem;
e) a run-time infrastructure (RTI) for providing interoperability between said first and second application interface subsystems;
f) a communications subsystem for providing data communication between said first facility subsystem and said second facility subsystem; and,
g) a connection subsystem for providing connectivity between said first network subsystem and said second network subsystem, wherein
both plug and play interoperability of said first and second user application systems and management of the data communication between said user application systems are accomplished.

10. The data distribution infrastructure of claim 9, wherein said RTI utilizes a high-level architecture (HLA) IEEE 1516 standard.

11. The data distribution infrastructure of claim 9, wherein said communications subsystem comprises a virtual private connection system.

12. The data distribution infrastructure of claim 9, wherein said connection subsystem comprises a point to point tunneling protocol (PPTP).

13. The data distribution infrastructure of claim 9, wherein said user application systems use the ANSI standard HL7 specification.

14. The data distribution infrastructure of claim 9, wherein said user application systems use the DICOM specification.

15. A data distribution infrastructure for providing homeland security, comprising:
a) a first user application system operable by a first user for communicating data with a second user, said first user application system comprising a first infrastructure interface element, said first user application being non-simulated and being homeland security related;
b) a second user application system operable by the second user for communicating data with said first user application system, said second user application system comprising a second infrastructure interface element, said second user application being non-simulated and being homeland security related;
c) a first infrastructure subsystem for providing interoperability between said first user application system and said second user application system, comprising:
i) a first application interface subsystem in data communication with said first infrastructure interface element;
ii) a first facility subsystem in data communication with said first application interface subsystem; and,
iii) a first network subsystem in data communication with said first facility subsystem;
d) a second infrastructure subsystem for providing interoperability between said first user application system and said second user application system, comprising:
i) a second application interface subsystem in data communication with said second infrastructure interface element;
ii) a second facility subsystem in data communication with said second application interface subsystem; and,
iii) a second network subsystem in data communication with said second facility subsystem;
e) a run-time infrastructure (RTI) for providing interoperability between said first and second application interface subsystems;
f) a communications subsystem for providing data communication between said first facility subsystem and said second facility subsystem; and,
g) a connection subsystem for providing connectivity between said first network subsystem and said second network subsystem, wherein
both plug and play interoperability of said first and second user application systems and management of the data communication between said user application systems are accomplished.
